(19) United States
(12) Patent Application Publication
(10) Pub. No.: US 2011/0302084 A1
(43) Pub. Date: Dec. 8, 2011

(54) SYSTEM AND METHOD FOR IMMEDIATE REPLACEMENT OF LOST OR STOLEN CREDIT CARDS/DEBIT CARDS

(76) Inventors: Stefan Melik-Aslanian, New York, NY (US); Linda Malek-Aslanian, New York, NY (US)

(21) Appl. No.: 13/152,236

(22) Filed: Jun. 2, 2011

Related U.S. Application Data
(60) Provisional application No. 61/350,770, filed on Jun. 2, 2010.

(51) Int. Cl. G06Q 40/00

(52) U.S. Cl. 705/44; 705/39

(57) ABSTRACT

A method and system for providing uninterrupted access to a credit or debit card account with:
a) a provider opening a credit or debit card account and the account being maintained by the provider,
b) linking an initially active physical card to the account, as a main account card,
c) linking an initially non-active non-physical virtual credit or debit card as a virtual account card to the credit or debit card account respectively, and
d) configuring the account such that with loss or theft of the physical card and the provider being notified thereof, the physical credit or debit main card access to the account is deactivated and access to the account by the non-physical virtual account card is immediately activated and the card holder is advised of the different card number whereby the card holder is able to maintain uninterrupted access to the credit or debit account

### BACKGROUND

1. Field of the Invention

The present invention relates to credit/debit cards, and more specifically, a method and system offering immediate replacement use of lost or stolen credit/debit cards.

2. Related Art

The potential for fraud in case a credit/debit card is lost or stolen has been a major concern for the credit card companies and financial institutions as well as the customers and the providers of the goods and services. Hereinafter, reference to “credit” cards, unless otherwise noted, encompasses both credit and debit cards. There have been many developments in an effort to overcome this fundamental problem of fraud. The credit card companies have an efficient credit card fraud protection system which is working well to block a lost or stolen credit card. The credit card companies also have an efficient credit card replacement system, which has been working well, to issue and send a new credit card to the customer in case their card has been lost or stolen. Most credit card companies claim that they can replace a lost or stolen credit card within 24 to 48 hours, if the customer carries the emergency replacement feature. But this replacement time period of 24 to 48 hours can be critical in many situations where the customer might need use of his/her card immediately, for example, while traveling out of town or being in an emergency situation. Therefore, a need exists for an improved system for use replacement of lost or stolen credit cards.

### SUMMARY OF THE INVENTION

The present invention is directed towards improving the existing credit card replacement system, by providing immediate use replacement of a lost, stolen or defective card. The problem for credit card replacement as noted above can be minimized in accordance with the principles of the present invention, by providing an additional “Deactivated” credit card number to the customer's account.

The credit card company opens one account with two different card numbers, a first card number for the “Main Credit Card” and a different second card number for the “Virtual Spare Credit Card”. The Virtual Spare Credit Card information is not in a card form and is not sent to the customer. The Virtual Spare Credit Card Information is maintained in the customer account data bank. The credit card company provides the customer with one credit card, “Main Credit Card”. The “Main Credit Card” will function identically to the existing credit cards. The number for the “Virtual Spare Credit Card” will remain “Deactivated” and will be “Activated” for use, only when the “Main Credit Card” number is reported as lost, stolen or defective by the customer to the credit card company. Both credit card numbers will never be activated at the same time. The credit card company will only “Activate” the “Main Credit Card” number, after receiving confirmation from the customer that he/she has received the Main Credit Card. The number for the “Virtual Spare Credit Card” will remain “Deactivated”.

When the customer reports his/her lost or stolen credit card to the company, the credit card company “Deactivates” (blocks) the first or “Main Credit Card” number and “Activates” the second or “Virtual Spare Credit Card” number until a New Main Credit Card is issued and sent to the customer. The credit card company will then replace the “Deactivated (blocked) credit card number (first or Main credit card number) with a new number and will send a New Main Credit Card for the customer.

After conducting the necessary security check (such as mother's maiden name, etc.) to confirm the customer's identity, the “Virtual Spare Credit Card” number, expiration date, security codes (such as CVV2, etc.) and an access code (depending on the credit card company policy) is provided by the card provider to the customer by phone. The credit card provider will also send a text message or email to the customer for further confirmation of the “Virtual Spare Credit Card” Information. The customer retains this information at his/her possession to be used temporarily, until the New Main Credit Card is received.

The customer can now conduct purchases both in card present (face to face transactions) and card-not-present environment (online or telephone transactions). In card present environment (such as stores, restaurants, hotels, etc.), the “Virtual Spare Credit Card” information will be manually entered in the card reader machine. If needed, the merchant will call the credit card authorization center (e.g. Code 10 authorization) to confirm the “Virtual Spare Credit Card” information in-order to proceed with the transaction. In some instances the operator at the authorization center will ask to talk directly to the customer to confirm the identity by conducting the security check. The customer can also use the “Virtual Spare Credit Card” information to get cash back from any bank or hotel (if the customer is staying at a hotel).

Upon receipt of the New Main Credit Card, the customer will call the credit card provider to inform them that he/she has received the New Main Credit Card. Then the Credit card provider will “Activate” the New Main Credit Card and will “Deactivate” the “Virtual Spare Credit Card” number. If after “X” period of time (the time period will be determined by the credit card provider), the customer fails to confirm the receipt of the New Main Credit Card, then the credit card provider will “Deactivate” the “Virtual Spare Credit Card” number, for further investigation.

After the validity date of the Main Credit Card has expired, the credit card provider will issue and send a New Main Credit Card to the customer. The “Virtual Spare Credit Card” number can also be changed or can remain the same, according to credit card company policy.

Generally the present invention comprises a system and method comprising:

for providing uninterrupted access to a credit or debit card account with loss or theft of an account credit or debit card, the system comprising:
a) an opened credit or debit card account from a provider and the account being maintained by the provider,
b) a physical credit or debit card initially actively linked to the account, for access thereto as a main account card, with account information contained thereon of: card holder name, card number, expiration date and security code,
c) an initially non-activated non-physical virtual credit or debit card as a virtual account card linked to the credit or debit card account respectively, the virtual account card having the same card holder name and different card number, the virtual credit or debit card number being stored by the provider apart from the physical credit or debit card and linked to the same credit or debit account,

wherein the system is configured such that, with loss or theft of the physical credit or debit card and the provider being notified thereof, the physical credit or debit main card access to the account is deactivated and access to the account by the non-physical virtual credit or debit virtual account card is immediately activated and the card holder is advised of the virtual card number, whereby the card holder is able to maintain uninterrupted access to the credit or debit account.

As an optional preferred feature the system further comprises, with activation of the non-physical virtual credit or debit virtual account card, the generation by the provider of a second physical main account card with a card number different from that of the initial physical credit or debit card. The second physical credit or debit card is provided to the card holder with acknowledgment of receipt by the card holder and the virtual credit or debit virtual account card is deactivated and the second physical credit or debit card is activated. If the second physical credit or debit card is lost or stolen the procedure is repeated with the second card becoming the main card, as above, with repeated use of the virtual credit or debit card or with a newly generated virtual credit or debit card.

The above and other objects, features and advantages of the present invention will become apparent from the following description of illustrative embodiments thereof to be read in conjunction with the accompanying drawings, in which like reference numerals represent the same or similar elements.

It is to be understood, however, that the drawings are designed solely for purpose of illustration and not as a definition of the invention.

### BRIEF DESCRIPTION OF THE DRAWINGS

The foregoing, and other, objects, features and advantages of the present invention will be more readily understood upon reading the following detailed description in conjunction with the drawings in which:

FIG. 1 is a front side view of the “Main Credit Card” showing the name (card holder), validity date and credit card number. The “Virtual Spare Credit Card” (Information) is representatively shown with the same name (card holder) and validity date, but with a different credit card number. The “Main Credit Card” is shown as “Activated” and the “Virtual Spare Credit Card” (Information) is shown as “Deactivated”.

FIG. 2 is a back side view of the “Main Credit Card”, showing card holder signature space, customer service contact numbers and security code. The “Virtual Spare Credit Card” (Information) is representatively also shown with a security code. The “Main Credit Card” is shown as “Activated” and “Virtual Spare Credit Card” (Information) is shown as “Deactivated”.

FIG. 3 is a front side view of the “Main Credit Card” shown as “Lost/Stolen”. The Virtual Spare Credit Card (Information) is representatively shown with name (card holder), validity date and card number as shown in FIG. 1. Virtual Spare Credit Card (Information) is shown as “Deactivated”.

FIG. 4 is a front side view of the “Main Credit Card” shown as “Lost/Stolen”. The Virtual Spare Credit Card (Information) is representatively shown with name (card holder), validity date and card number as shown in FIGS. 1 and 3. Virtual Spare Credit Card (Information) is shown as “Activated” and the “Main Credit Card” is shown as “Deactivated”.

FIG. 5 is a “New Main Credit Card” being shown with a new card number with the same name and validity date. The “Virtual Spare Credit Card” (Information) is representatively shown with the name (card holder), validity date and card number as indicated in FIGS. 1, 3 and 4. The “Virtual Spare Credit Card” (Information) is shown as “Activated” and the “New Main Credit Card” is shown as “Deactivated”.

FIG. 6 is a “New Main Credit Card” showing new card number with the same name and validity date. The “Virtual Spare Credit Card” (Information) is representatively shown with name (card holder), validity date and card number as indicated in FIGS. 1, 3, 4 and 5. The “Virtual Spare Credit Card” (Information) is shown as “Deactivated” and the “New Main Credit Card” is shown as “Activated”.

FIG. 7 is a front and back side view of the “Credit Card ID”. The front side view showing, name (card holder), card number and validity date. The back side view showing, card holder signature space and customer service contact numbers.

FIG. 8 is a procedural flow chart of the credit card system with a single account embodiment: and

FIG. 9 is a procedural flow chart of the credit card system with an embodiment with two accounts.

### DETAILED DESCRIPTION

In this specification:
1. The term “Main Credit Card” refers to credit cards (Master Card®, Visa®, Diners Club®, etc.) as well as charge cards (e.g., American Express®, some department store cards), debit cards such as usable at ATMs and many other locations or that are associated with a particular account, and hybrids thereof (e.g., extended payment American Express®, bank debit cards with the Visa® logo, etc.).
2. The term “Virtual Spare Credit Card” Information refers to identification information such as credit card number, expiration date, security codes (such as CVV2, etc.) and an access code or any other security code (depending on the credit card company policy). The “Virtual Spare Credit Card” is not in a card form but rather in the form of data pertaining to a virtual credit card.

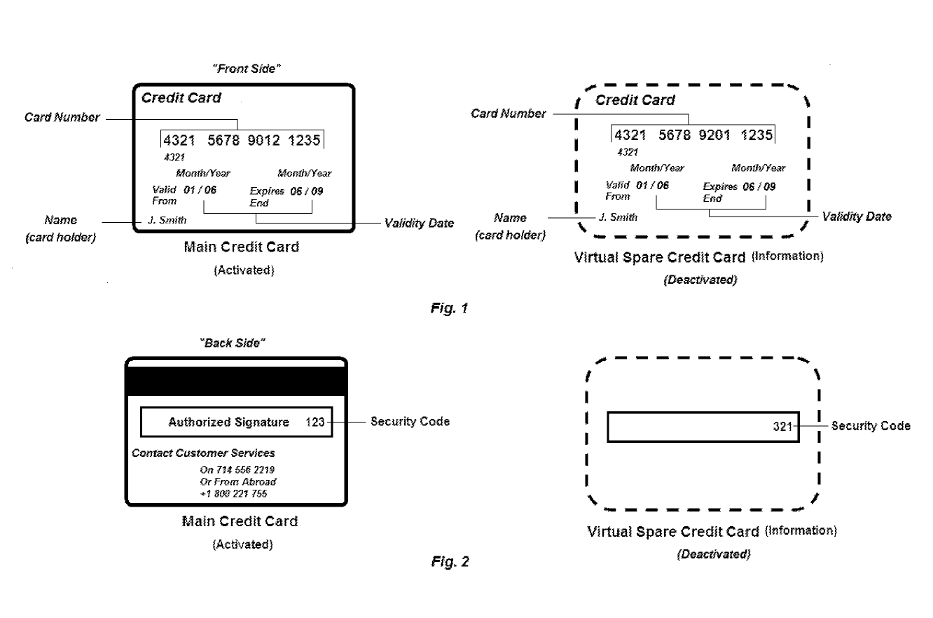

Referring to FIG. 1, the “Main Credit Card” is shown from the front side with basic identification information such as, a card number, name (card holder) and validity date. The term “Main Credit Card” refers to credit cards as generally understood, namely, that which are allocated by the credit card provider to the customer. The “Virtual Spare Credit Card” (Information) is also representatively shown with basic identification information such as, a card number, name (card holder) and validity date. The “Main Credit Card” number is different from the “Virtual Spare Credit Card” number, but the name of the card holder and the validity dates on both credit cards are the same. Since each credit card company (credit card provider) has a different card numbering system, the structure of both credit card numbers varies depending on the credit card company system.

The “Main Credit Card” number is “Activated” as soon as the customer confirms the receipt of the “Main Credit Card” to the Credit card provider. The “Virtual Spare Credit Card” number remains “Deactivated” as shown in FIG. 1.

Referring again to FIG. 1, the credit card provider opens one account with two different card numbers, a first card number for the “Main Credit Card” and a second card number for the “Virtual Spare Credit Card”. The Credit card provider sends a package with one credit card to the customer, “Main Credit Card”. Upon receipt of the package, the customer calls the Credit Card provider to inform them that he/she has received the credit card. Then the Credit Card provider will “Activate” only the “Main Credit Card” number. The “Virtual Spare Credit Card” number will remain “Deactivated”.

According to the company policy the credit card company (Credit card provider) will either provide one Personal Identification Number (PIN) for both “Main Credit Card” and “Virtual Spare Credit Card”, or two different Personal Identification Numbers (PIN) allocated to each one of the two credit cards.

If the customer already has a credit or debit card, then the credit card company will add an additional new card number to the existing credit card account, to be used as the second credit card number (Virtual Spare Credit Card).

After the validity date of the Main Credit Card has expired, the credit card provider will issue and send a New Main Credit Card to the customer. The “Virtual Spare Credit Card” number can also be changed or can remain the same, according to credit card company policy.

Referring to FIG. 2, the “Main Credit Card” is shown from the back side with basic information such as, card holder signature space, customer service contact numbers and security code (such as CVV2). The Virtual Spare Credit Card (Information) is also representatively shown with the security code (such as CVV2). The “Main Credit Card” number will be “Activated” as soon as the customer confirms the receipt of the “Main Credit Card” to the credit card provider as shown and described in FIG. 1. The “Virtual Spare Credit Card” number will remain “Deactivated”.

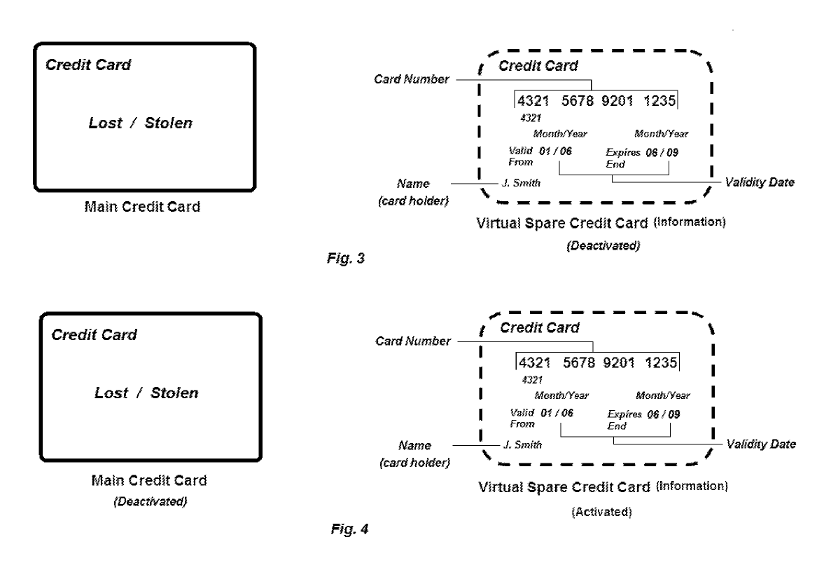

Referring to FIG. 3, the “Main Credit Card” is shown as “Lost/Stolen”. The “Virtual Spare Credit Card” (Information) is representatively shown as described in FIG. 1. The “Virtual Spare Credit Card” number remains “Deactivated”.

Referring again to FIG. 3, the customer (card holder) calls the credit card center or calls the numbers listed on the back side of the “Main Credit Card”, if a copy of the back side of the Main Credit Card is at his/her possession, to report “Lost/Stolen” credit card (Main Credit Card).

For security reasons and fraud prevention, the credit card provider will ask the customer's (card holder) name and other information (such as mother's maiden name, etc.), to confirm the customer's identity.

Referring to FIG. 4, the “Virtual Spare Credit Card” (Information) is shown as described in FIGS. 1 and 3. Once the customer's identity is confirmed, the credit card provider will block and “Deactivate” the “Main Credit Card” number and will “Activate” the “Virtual Spare Credit Card” number. The “Main Credit Card” is “Deactivated” and the “Virtual Spare Credit Card” number is “Activated”, as shown in FIG. 4. The credit card provider will issue a “New Main Credit Card” and will send a “New Main Credit Card” to the customer.

Referring again to FIG. 4, after confirmation of the customer's identity, the “Virtual Spare Credit Card” number, expiration date, security codes (such as CVV2, etc.) and an access code (depending on the credit card company policy) is provided by the card provider to the customer by phone. The credit card provider will also send a text message or email to the customer for further confirmation of the “Virtual Spare Credit Card” Information. The customer retains this information at his/her possession to be used temporarily, until the “New Main Credit Card” is received.

The customer can now conduct purchases both in card present (face to face transactions) and card-not-present environment (online or telephone transactions). In card present environment (such as stores, restaurants, hotels, etc.), the “Virtual Spare Credit Card” information will be manually entered in the card reader machine. If needed, the merchant will call the credit card authorization center (e.g. Code 10 authorization) to confirm the “Virtual Spare Credit Card” information in-order to proceed with the transaction. In some instances the operator at the authorization center will ask to talk directly to the customer to confirm the identity by conducting security check. The customer can also use the “Virtual Spare Credit Card” information to get cash back from any bank or hotel (if the customer is staying at a hotel).

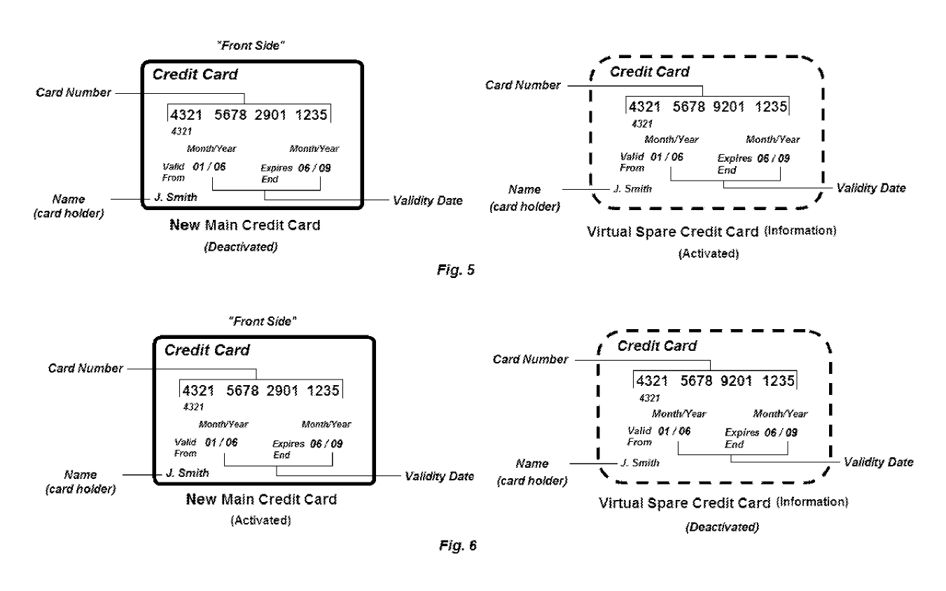

Referring to FIG. 5, the “New Main Credit Card” is shown from the front side, with a new card number, but with the same validity date (the validity date can remain the same or can be changed according to the credit card company policy). The “Virtual Spare Credit Card” (Information) is also representatively shown with the same card number and validity date as shown in FIGS. 1, 3 and 4. The “New Main Credit Card” number is “Deactivated” and the “Virtual Spare Credit Card” number is “Activated” as shown in FIG. 5.

Referring to FIG. 6, the “New Main Credit Card” is shown from the front side. The “Virtual Spare Credit Card” (Information) is also representatively shown with the same card number and validity date as shown in FIGS. 1, 3, 4 and 5. Upon receipt of the “New Main Credit Card”, the customer will call the credit card provider to confirm that he/she has received the “New Main Credit Card”. The credit card provider will then “Deactivate” the “Virtual Spare Credit Card” number and will “Activate” the “New Main Credit Card” number, as shown in FIG. 6. If after “X” period of time (the time period will be determined by the credit card provider), the customer fails to confirm the receipt of the New Main Credit Card, the credit card provider will “Deactivate” the “Virtual Spare Credit Card” number, for further investigation

Now the customer can use the “New Main Credit Card”. The “Virtual Spare Credit Card” number will remain Deactivated by the credit card provider, for future use.

After the validity date of the “Main Credit Card” has expired, the credit card provider will issue and send a “New Main Credit Card” to the customer. The “Virtual Spare Credit Card” number can also be changed or can remain the same, according to credit card company policy.

According to the company policy the credit card company (Credit card provider) will either provide one Personal Identification Number (PIN) for both “Main Credit Card” and “Virtual Spare Credit Card”, or two different Personal Identification Numbers (PIN) allocated to each one of the credit cards.

Since the system does not require a physical spare credit card, the customer is not burdened to carry any spare cards. Therefore the customer has the option to obtain the above mentioned “Virtual Spare Credit Card” service either for one credit or debit card or for several credit cards from the same brand.

While the foregoing description makes reference to particular illustrative embodiments, these examples should not be construed as limitations. Thus, the present invention is not limited to the disclosed embodiments.

Option 1

### Summary

The credit card company opens two accounts with two different card numbers, first account for the “Main Credit Card” and second account for the “Virtual Spare Credit Card”.
When the credit card is lost/stolen, the customer uses the “Virtual Spare Credit Card” Information until a New Main Credit Card is issued and sent to the customer.
Upon receipt of the package, the customer will call the credit card provider to inform them that he/she has received the New Main Credit Card. Then the credit card provider will “Activate” the New Main Credit Card and will transfer the whole account (balance of credit) from the “Virtual Spare Credit Card” account into the New Main Credit Card account. The “Virtual Spare Credit Card” account will be “Deactivated”.
The customer can now use the “New Main Credit Card”. The “Virtual Spare Credit Card” number will remain “Deactivated” by the credit card provider, for future use.

In this specification:
1. The term “Main Credit Card” refers to credit cards (Master Card®, Visa®, Diners Club®, etc.) as well as charge cards (e.g., American Express®, some department store cards), debit cards such as usable at ATMs and many other locations or that are associated with a particular account, and hybrids thereof (e.g., extended payment American Express®, bank debit cards with the Visa® logo, etc.).
2. The term “Virtual Spare Credit Card” Information refers to identification information such as credit card number, expiration date, security codes (such as CVV2, etc.) and an access code or any other security code (depending on the credit card company policy). The “Virtual Spare Credit Card” is not in a card form but rather in the form of data pertaining to a virtual credit card.

Referring to FIG. 1, the “Main Credit Card” is shown from the front side with basic identification information such as, a card number, name (card holder) and validity date. The term “Main Credit Card” refers to credit cards as generally understood, namely, that which are allocated by the credit card provider to the customer. The “Virtual Spare Credit Card” (Information) is also representatively shown with basic identification information such as, a card number, name (card holder) and validity date. The “Main Credit Card” number is different from the “Virtual Spare Credit Card” number, but the name of the card holder and the validity dates on both credit cards are the same. Since each credit card company (credit card provider) has a different card numbering system, the structure of both credit card numbers vary depending on the credit card company system.

The “Main Credit Card” number will be “Activated” as soon as the customer confirms the receipt of the “Main Credit Card” to the Credit card provider. The “Virtual Spare Credit Card” number will remain “Deactivated” as shown in FIG. 1.

Referring again to FIG. 1, the credit card provider will open two accounts with two different card numbers, first account for the “Main Credit Card” and second account for the “Virtual Spare Credit Card”. Then the credit card provider will send a package with one credit card to the customer, “Main Credit Card”. Upon receipt of the package, the customer will call the credit card provider to inform them that he/she has received the credit card. Then the credit card provider will “Activate” only the “Main Credit Card” number. The “Virtual Spare Credit Card” number will remain “Deactivated”. According to the company policy the credit card company (Credit card provider) will either provide one Personal Identification Number (PIN) for both “Main Credit Card” and “Virtual Spare Credit Card”, or two different Personal Identification Numbers (PIN) allocated to each one of the credit cards.

If the customer already has a credit or debit card, then the credit card company will add an additional new account and card number to the existing credit card account, to be used as the second credit card number (Virtual Spare Credit Card).

After the validity date of the Main Credit Card has expired, the credit card provider will issue and send a New Main Credit Card to the customer. The “Virtual Spare Credit Card” number can also be changed or can remain the same, according to the credit card company policy.

Referring to FIG. 2, the “Main Credit Card” is shown from the back side with basic information such as, card holder signature space, customer service contact numbers and security code (such as CVV2). The “Virtual Spare Credit Card” (Information) is also representatively shown with the security code (such as CVV2). The “Main Credit Card” number will be “Activated” as soon as the customer confirms the receipt of the “Main Credit Card” to the credit card provider as shown and described in FIG. 1. The “Virtual Spare Credit Card” number will remain “Deactivated”.

Referring to FIG. 3, the “Main Credit Card” is shown as “Lost/Stolen”. The “Virtual Spare Credit Card” (Information) is representatively shown as described and shown in FIG. 1. The “Virtual Spare Credit Card” number remains “Deactivated”.

Referring again to FIG. 3, the customer (card holder) calls the credit card center or calls the numbers listed on the back side of the “Main Credit Card”, if a copy of the back side of the Main Credit Card is at his/her possession, to report “Lost/Stolen” credit card (Main Credit Card).

For security reasons and fraud prevention, the credit card provider will ask the customer's (card holder) name and other information (such as mother's maiden name, etc.), to confirm the customer's identity.

Referring to FIG. 4, the “Spare Credit Card (Information) is shown as described and shown in FIGS. 1 and 3. Once the customer's identity is confirmed, the credit card provider will block or “Deactivate” the first account “Main Credit Card” and will transfer the whole account (balance of credit) in the “Main Credit Card” into the “Virtual Spare Credit Card” account and will “Activate” the “Virtual Spare Credit Card” number. The “Main Credit Card” is “Deactivated” and the “Virtual Spare Credit Card” number is “Activated”, as shown in FIG. 4. The credit card provider will issue a “New Main Credit Card” and will send a “New Main Credit Card” to the customer.

Referring again to FIG. 4, after confirmation of the customer's identity, the “Virtual Spare Credit Card” number, expiration date, security codes (such as CVV2, etc.) and an access code (depending on the credit card company policy) is provided by the card provider to the customer by phone. The credit card provider will also send a text message or email to the customer for further confirmation of the “Virtual Spare Credit Card” Information. The customer retains this information at his/her possession to be used temporarily, until the “New Main Credit Card” is received.

The customer can now conduct purchases both in card present (face to face transactions) and card-not-present environment (online or telephone transactions). In card present environment (such as stores, restaurants, hotels, etc.), the “Virtual Spare Credit Card” information will be manually entered in the card reader machine. If needed, the merchant will call the credit card authorization center (e.g. Code 10 authorization) to confirm the “Virtual Spare Credit Card” information in-order to proceed with the transaction. In some instances the operator at the authorization center will ask to talk directly to the customer to confirm the identity by conducting security check. The customer can also use the “Virtual Spare Credit Card” information to get cash back from any bank or hotel (if the customer is staying at a hotel).

Referring to FIG. 5, the “New Main Credit Card” is shown from the front side, with a new card number, but with the same validity date (the validity date can remain the same or can be changed according to the credit card company policy). The “Virtual Spare Credit Card” (Information) is also representatively shown with the same card number and validity date as shown in FIGS. 1, 3 and 4. The “New Main Credit Card” number is “Deactivated” and the “Virtual Spare Credit Card” number is “Activated” as shown in FIG. 5.

Referring to FIG. 6, the “New Main Credit Card” is shown from the front side. The “Virtual Spare Credit Card” (Information) is also representatively shown with the same card number and validity date as shown in FIGS. 1, 3, 4 and 5. Upon receipt of the “New Main Credit Card”, the customer will call the credit card provider to confirm that he/she has received the “New Main Credit Card”. Then the Credit card provider will “Activate” the “New Main Credit Card” account and will transfer the whole account (balance of credit) from the “Virtual Spare Credit Card” account into the “New Main Credit Card” account. The “Virtual Spare Credit Card” number will be “Deactivated” as shown in FIG. 6. If after “X” period of time (the time period will be determined by the credit card provider), the customer fails to confirm the receipt of the New Main Credit Card, the credit card provider will “Deactivate” the “Virtual Spare Credit Card” number, for further investigation

Now the customer can use the “New Main Credit Card”. The “Virtual Spare Credit Card” number will remain Deactivated by the credit card provider, for future use.

After the validity date of the “Main Credit Card” has expired, the credit card provider will issue and send a “New Main Credit Card” to the customer. The “Virtual Spare Credit Card” number can also be changed or can remain the same, according to credit card company policy.

According to the company policy the credit card company (Credit card provider) will either provide one Personal Identification Number (PIN) for both “Main Credit Card” and “Virtual Spare Credit Card”, or two different Personal Identification Numbers (PIN) allocated to each one of the credit cards.

Since the system does not require a physical spare card, the customer is not burdened to carry any spare cards. Therefore the customer has the option to obtain the above mentioned “Virtual Spare Card” service either for one credit or debit card or for several credit cards from the same brand.

While the foregoing description makes reference to particular illustrative embodiments, these examples should not be construed as limitations. Thus, the present invention is not limited to the disclosed embodiments.

Option 2

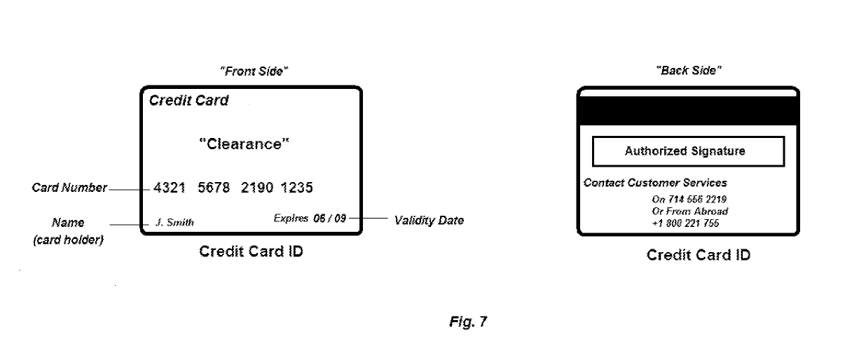

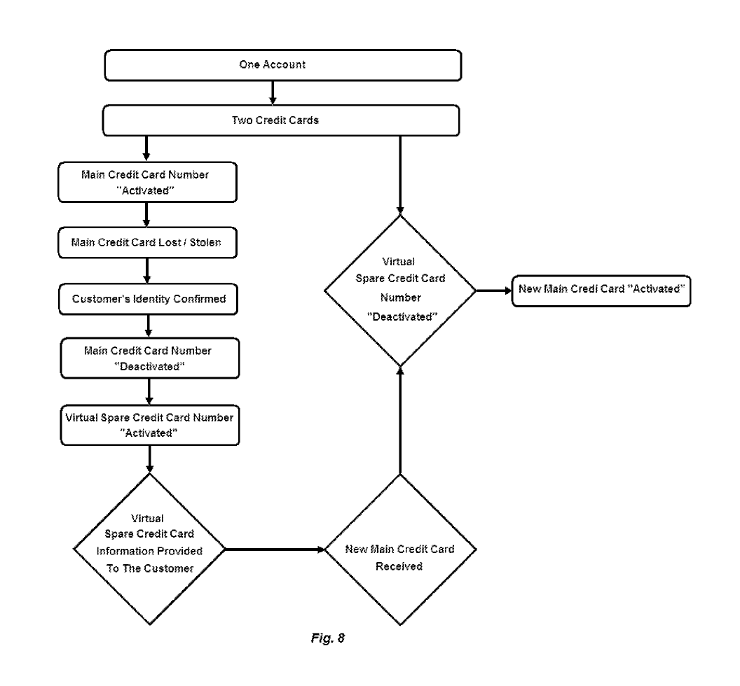

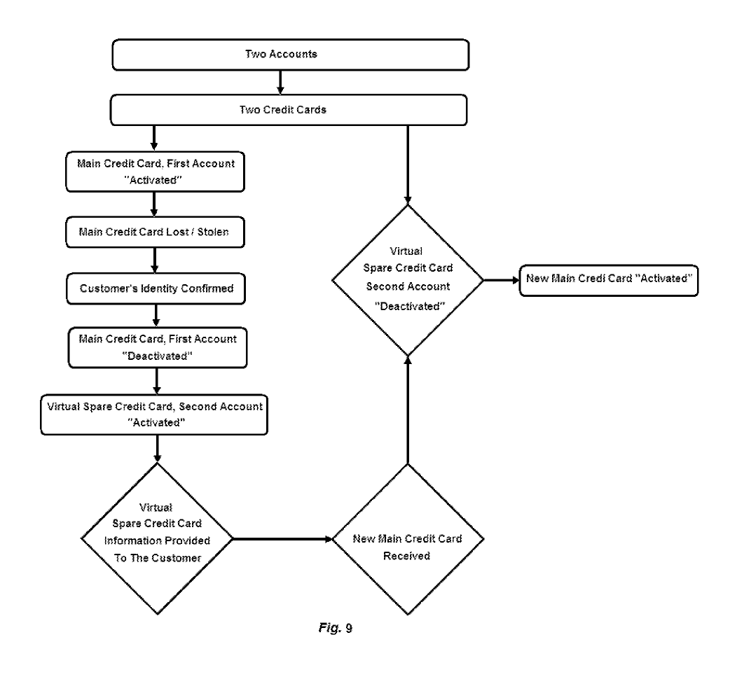

Referring to FIG. 7, a “Credit Card ID” is shown from the front side indicating the card holder name, validity date, card number and from the back side indicating card holder signature space and customer service contact numbers. A “Credit Card ID” acts as a “clearance” card and is provided to the customer for enhanced security. The “clearance” card has the customer's name, a card number embossed on the front side and a signature space and customer service contact numbers on the back side.

The “Credit Card ID” is an additional security tool for confirmation of the following two identity check points:
1. Activation of “Virtual Spare Credit card”: To expedite the security check process prior to providing the “Virtual Spare Credit Card” information, the card provider will ask the customer for the “Credit Card ID” number (if available). Nevertheless the credit card provider will not decline the customer's request for the “Virtual Spare Credit Card” information once the customer passes the security check.
2. Point of Sale: The merchant will ask for the “Credit Card ID” (if available) in order to validate the customer signature. The “Credit Card ID” number is requested when the credit card authorization center (e.g. Code 10 authorization) is contacted for confirmation of the “Virtual Spare Credit Card” information presented at the point of sale. Nevertheless if the customer is unable to present the “Credit Card ID”, the merchant will not refuse to provide service to the customer, once the customer passes the security check.

The “Credit Card ID” is useful in the following situations:
1. Lost or stolen credit card: The customer reports his/her lost or stolen credit card, by calling the customer service contact numbers printed on the back side of the “Credit Card ID”.
2. Lost or stolen main ID: The customer uses the “Credit Card ID” if his/her main identification document (such as passport) has also been lost/stolen, especially while traveling. The “Credit Card ID” can only be used in the two identity check point instances mentioned above and cannot be used in lieu of a passport in other identity verification cases.

The customer should never carry the “Credit Card ID” along with his/her credit cards (such as purse or wallet). The “Credit Card ID” should be kept in a separate and safe place, such as at home/hotel room or any place he/she is residing at that time.

If the customer already has a “Virtual Spare Credit Card” number, then the credit card provider will add the “Credit Card ID” number to the existing credit card account.

Regardless of the quantity of “Virtual Spare Credit card” numbers obtained by the customer, only one “Credit Card ID” per credit card brand is required. A single “Credit Card ID” per credit card brand covers the ID requirement for different “Virtual Spare Credit Card” numbers issued by different issuers under the same credit card brand.

While the foregoing description makes reference to particular illustrative embodiments, these examples should not be construed as limitations. Thus, the present invention is not limited to the disclosed embodiments except as in the following claims

What is claimed is:

1. A system for providing uninterrupted access to a credit or debit card account with loss or theft of an account credit or debit card, the system comprising:
a) an opened credit or debit card account from a provider and the account being maintained by the provider,
b) a physical credit or debit card initially actively linked to the account, for access thereto as a main account card, with account information contained thereon of: card holder name, card number, expiration date and security code,
c) an initially non-activated non-physical virtual credit or debit card as a virtual account card linked to the credit or debit card account respectively, the virtual account card having the same card holder name and different card number, the virtual credit or debit card number being stored by the provider apart from the physical credit or debit card and linked to the same credit or debit account,
wherein the system is configured such that, with loss or theft of the physical credit or debit card and the provider being notified thereof, the physical credit or debit main card access to the account is deactivated and access to the account by the non-physical virtual credit or debit virtual account card is immediately activated and the card holder is advised of the virtual card number, whereby the card holder is able to maintain uninterrupted access to the credit or debit account.

2. The system of claim 1, wherein the system further comprises, with activation of the non-physical virtual credit or debit virtual account card, the generation by the provider of a second physical main account card with a card number different from that of the initial physical credit or debit card, the second physical credit or debit card being provided to the card holder wherein with acknowledgment of receipt by the card holder, the virtual credit or debit virtual account card is deactivated and the second physical credit or debit card is activated.

3. The system of claim 1, wherein the initially non-activated non-physical virtual credit or debit card as a virtual account card is linked to an prior existing credit or debit card account respectively.

4. The system of claim 1, wherein the initially non-activated non-physical virtual credit or debit card as a virtual account card is linked to a credit or debit card account at an initial opening of the credit or debit card account.

5. The system of claim 1, wherein the system further comprises a security check system adapted to verify an authentic user of the activated virtual credit or debit card.

6. The system of claim 1, wherein the card holder is provided with a credit card ID with information thereon for confirmation of the card holder's identity when using the activated virtual debit or credit card.

7. The system of claim 1, wherein the card holder is provided with an option to keep the virtual debit or credit card active and wherein the expiration date of the original physical credit or debit card is applied to the virtual credit or debit card.

8. A method for providing uninterrupted access to a credit or debit card account with loss or theft of an account credit or debit card, the method comprising the steps of:
a) opening a credit or debit card account from a provider and the account being maintained by the provider,
b) linking an initially active physical credit or debit card to the account, for access thereto as a main account card, with account information contained thereon of: card holder name, card number, expiration date and security code,
c) linking an initially non-active non-physical virtual credit or debit card as a virtual account card to the credit or debit card account respectively, the virtual account card having the same card holder same and different card number, the virtual credit or debit card number and security code being stored by the provider apart from the physical credit or debit card and linked to the same credit or debit account,
d) configuring the account such that with loss or theft of the physical credit or debit card and the provider being notified thereof, the physical credit or debit main card access to the account is deactivated and access to the account by the non-physical virtual credit or debit virtual account card is immediately activated and the card holder is advised of the different card number whereby the card holder is able to maintain uninterrupted access to the credit or debit account.

9. The method of claim 8, wherein, with activation of the non-physical virtual credit or debit virtual account card, the step of the provider generating a second physical main account card with a card number different from those of the initial physical credit or debit card, the second physical credit or debit card being provided to the card holder wherein with acknowledgment of receipt by the card holder, the virtual credit or debit virtual account card is deactivated and the second physical credit or debit card is activated.

10. The method of claim 8, wherein the initially non-activated non-physical virtual credit or debit card as a virtual account card is linked to an prior existing credit or debit card account respectively.

11. The method of claim 8, wherein the initially non-activated non-physical virtual credit or debit card as a virtual account card is linked to a credit or debit card account at an initial opening of the credit or debit card account.

12. The method of claim 8, wherein the system further comprises a security check system adapted to verify an authentic user of the activated virtual credit or debit card.

13. The method of claim 8, wherein the card holder is provided with a credit card ID with information thereon for confirmation of the card holder's identity when using the activated virtual debit or credit card.

14. The method of claim 9, wherein, in the absence of the acknowledgement of receipt by the card holder, the virtual credit or debit card is deactivated after a pre-determined period of time and the status of the second physical main account card is investigated.
